(19) United States
(12) Patent Application Publication
(10) Pub. No.: US 2003/0150241 A1
(43) Pub. Date: Aug. 14, 2003

(54) Production method of polarization maintaining fiber

(75) Inventors: Tetsuya Haruna, Kanagawa (JP); Hideyuki Iziri, Kanagawa (JP); Motohide Yoshida, Kanagawa (JP); Takahiro Seki, Kanagawa (JP)

Correspondence Address: McDERMOTT, WILL & EMERY, 600 13th Street, N.W., Washington, DC, 20005-3096, US

(73) Assignee: Sumitomo Electric Industries, Ltd.

(21) Appl. No.: 10/347,217

(22) Filed: Jan. 21, 2003

(30) Foreign Application Priority Data
Jan. 21, 2002 (JP) P. 2002-011108

(51) Int. Cl. C03B 37/027

(52) U.S. Cl. 65/409

(57) ABSTRACT

The invention provides a production method for a PMF. Two or more bores at regular intervals are formed in a glass rod including a core and a clad so that the bores may be located on a concentric circle around a center axis of the glass rod. A stress applying member is inserted into the bore. The glass rod and the stress applying member may be heated before or after inserting. The glass rod with the stress applying is drawn without exposure to the atmosphere after heating in order to form an optical fiber.

### BACKGROUND OF THE INVENTION

1. Field of the Invention

The present invention relates to a method for manufacturing a Polarization Maintaining fiber.

2. Description of the Related Art

A Polarization Maintaining fiber of stress applying type useful for an optical communication and an optical sensor using a coherent light maintains a predetermined plane of polarization by making a phase difference between E_{X} mode and E_{Y} mode (orthogonally biaxial direction) including a basic mode greater than a phase difference due to disturbance. (Hereinafter, Referring to a polarization maintaining fiber as PMF) One of the PMFs is a stress applying type using a birefringence phenomenon with the stress. The PMF maintains a polarized plane by applying the stress on a core.

In fabricating a PMF of stress applying type, as shown in FIG. 9, it is common practice to open two bores 13 at predetermined positions of a glass rod using clad 11 (positions on both sides of a glass rod for core 12). Then, a glass rod using a stress applying member 14 is inserted into each bore 13. And then, a glass rod using PMF 15 including the stress applying member 14 is drawn by known heating drawing means so that a PMF having stress applying members 2B is generally formed. The PMF has the stress applying members 2B, as shown in FIG. 11.

The stress applying members 2B are made of a glass having a uniform ingredient of SiO₂—B₂O₃, as seen from a concentration distribution shown in FIG. 10.

A thermal expansion coefficient of B₂ O₃ is greater than that of SiO₂. Therefore, the glass rod using PMF 15 including the glass rod for stress applying member 14 is drawn at high temperatures in order to produce an optical fiber. Then, if this optical fiber 5 is cooled to ordinary temperatures, a stress is applied from the stress applying members 2B to the core 1 so that a birefringence occurs in the core 1 due to this stress. By this stress, the optical fiber 5 has a Polarization Maintaining characteristic.

Here, as the B₂O₃ concentration is higher, more stress is applied on the core l so that the birefbingence characteristic is enhanced.

This stress applying members 2B applies stress between the stress applying members 2B and the clad 3 strongly, as well as on the corel. Therefore, if the B₂O₃ concentration is increased in order to make the birefringence characteristic better, the stress will be concentrated between the stress applying members 2B and the clad 3.

A following method was proposed. An inner diameter reduced member of the bore for a glass rod using optical fiber is formed at one end of the bore. The inner diameter reduced member has a smaller diameter than other members of the bore. Then, a first glass rod, the stress applying member and a second glass rod are inserted in this order from the other end member of the glass rod into the bore to place the first glass rod into contact with the bore diameter reduced member, and then a part of the second glass rod is fusion spliced with the glass rod. (JP-A-4-97920)

Another method was also offered in which a plurality of glass rods for waveguide having a plurality of cores contained within one clad are inserted into a plurality of through holes formed in the glass rod having a lower refractive index than a refractive index of the clad, respectively, and the glass rod is heat to integrate the glass rods for waveguide and the glass rod (JP-A-4-219707).

However, with the former method, there remains a dirt adherent substance within the bore and on the surface of the stress applying member after the stress applying member is inserted into the bore. Therefore, there is the possibility that an alien substance is foamed at the time of drawing. The alien substance causes to a fluctuation in the outer diameter of the optical fiber.

Also, with the latter method, the glass rod might be cracked at the time of integration. In producing the glass rod using PMF, when two kinds of the glass rod using for optical fiber and the glass rod using for the stress applying members were integrated after the stress applying members with different material are inserted into the glass rod using optical fiber, a Q interface between the stress applying members are compressed to deform or generate a cracking, so that a desired integration may not be achieved.

### SUMMARY OF THE INVENTION

It is an object of an invention to provide a Polarization Maintaining glass fiber that can prevent a fluctuation in the outer diameter without any cracking.

The invention provides a production method for a PMF. Two or more bores at regular intervals are formed in a glass rod including a core and a clad so that the two or more bores may be located on a concentric circle around a center axis of the glass rod. A stress applying member is inserted into the bore. The glass rod including the core and the clad and the stress applying member may be heated before or after inserting the stress applying member into the bore of the glass rod. The glass rod, into which the stress applying member is inserted, is drawn without exposure to the atmosphere in order to form a optical fiber.

It is preferable that said glass rod and the stress applying member are heated with a clearance between an outer side face of the stress applying member and an inner wall of the bore after inserting.

It is preferable that said glass rod and said stress applying member are heated at temperature to keep the clearance in a condition that a gas flows through the clearance.

It is preferable that said glass rod and said stress applying member are heated before inserting said stress applying member into said bores.

It is preferable that said glass rod and said stress applying member are heated at temperatures from 800 to 1500° C.

It is preferable that said glass rod and said stress applying member are heated in a halogen gas atmosphere.

It is preferable that said glass rod and said stress applying member are heated in a chlorine gas atmosphere.

It is preferable that said glass rod and said stress applying member are heated in an electric furnace.

It is preferable that said glass rod and said stress applying member are heated directly by flame.

### BRIEF DESCRIPTION OF THE DRAWINGS

FIG. 1 is a view showing a process of manufacturing a Polarization Maintaining glass fiber according to a first embodiment of the present invention;

FIG. 2 is a view showing a process of manufacturing a Polarization Maintaining glass fiber according to the first embodiment of the invention;

FIG. 3 is a view showing a process of manufacturing a Polarization Maintaining glass fiber according to the first embodiment of the invention;

FIG. 4A is a view showing a process of manufacturing a Polarization Maintaining glass fiber according to the first embodiment of the invention;

FIG. 4B is showing a sectional view of FIG. 4 that

FIG. 5 is a view showing-a process of manufacturing a Polarization Maintaining glass fiber according to the first embodiment of the invention;

FIG. 6 is a view showing a process of manufacturing a Polarization Maintaining glass fiber according to a second embodiment of the invention;

FIG. 7 is a view showing a process of manufacturing a Polarization Maintaining glass fiber according to the second embodiment of the invention;

FIG. 8 is a view showing a process of manufacturing a Polarization Maintaining glass fiber according to the second embodiment of the invention;

FIG. 9 is a view showing a process of manufacturing a conventional Polarization Maintaining glass fiber;

FIG. 10 is a graph showing the concentration distribution of a stress applying members 2B; and

FIG. 11 is a view showing a process of manufacturing the conventional Polarization Maintaining glass fiber.

### DESCRIPTION OF THE PREFERRED EMBODIMENTS

The preferred embodiments of the present invention will be described below in detail with reference to the accompanying drawings.

Embodiment 1

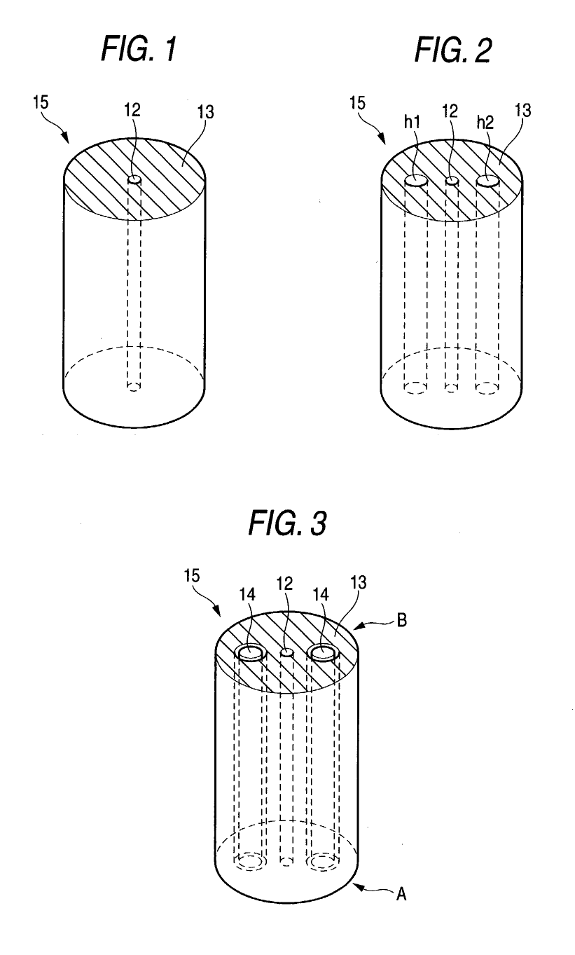

In a method for manufacturing a PMF according to a first embodiment of the invention as shown in FIGS. 1 to 5, a production method of a polarization maintaining fiber, the method comprising:

forming two or more bores at predetermined intervals in a glass rod including a core and a clad so that said two or more bores are located on a concentric circle around a center axis of said glass rod;

inserting a stress applying member into said bores;

heating said glass rod with said stress applying member in a condition that a clearance between an outer side face of said stress applying member and an inner wall of said bore keeps;

cleaning said outer side face of said stress applying member and said inner wall of said bore;

drawing said glass rod with said stress applying member without exposure to atmosphere.

Firstly, a glass cylinder as a glass rod 15 is prepared as shown in FIG. 1. The glass rod 11 has a core 12 having an outer diameter of 1.35 mm and a clad 13. The clad 13 includes a pure quartz glass. A germanium dioxide (GeO₂) is added to the core 12 so that the core 12 has higher refractive index than the clad.

The glass cylinder is formed by VAD method (vapor-phase axial deposition). Besides, the MCVD method (modified chemical vapor deposition), OVD method (outside vapor deposition), and rod in tube method, like the methods for the ordinary glass rod using optical fiber, may be employed.

Then, by using a boring machine (not shown), through holes h1 and h2 are formed in the clad 13. The through holes h1 and h2 have a diameter of 1/3.5 times that of the glass cylinder. The through holes extend along an axial direction of the glass cylinder(FIG. 2). The through holes h1 and h2 are formed in parallel to the core 12 at positions symmetrical with respect to a center axis of the core 12.

As shown in FIG. 3, a stress applying member 14 is inserted from a first end A of the glass cylinder having the through holes h1 and h2 to a second end B, as shown in FIG. 3. The stress applying member 14 includes a quartz rod added B₂O₃.

At this time, prior to inserting this stress applying member, a thicker dummy pipe 20B is welded on the B end side in order to prevent Boron passing from A end side to B end side.

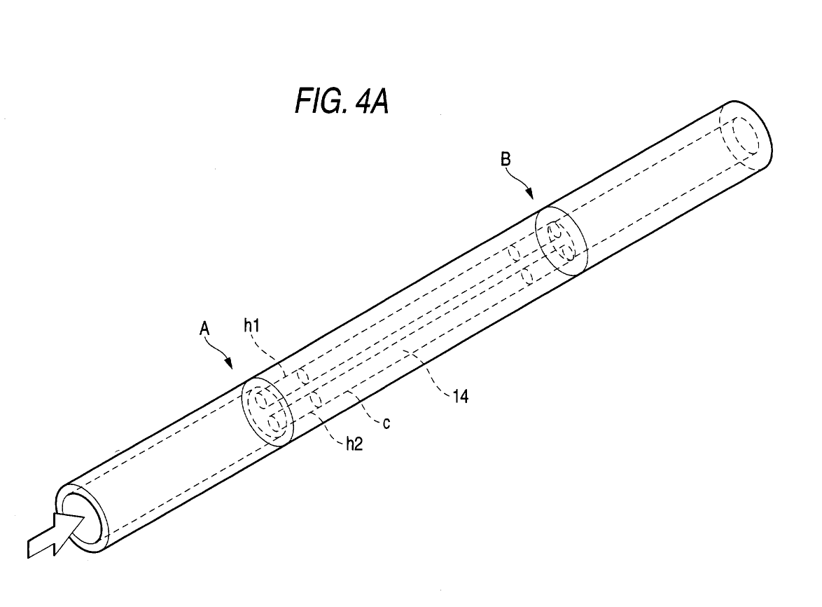

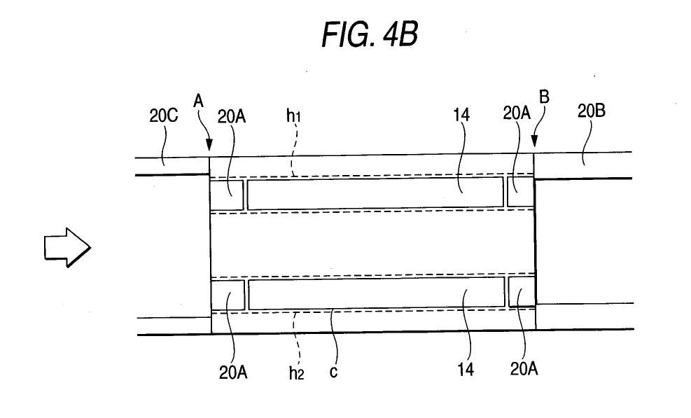

While a gas including 60% of a chlorine gas is flowed from A end side to B end side at 800 cc per minute and the glass rod 15 is being rotated at 5 rpm, a flame 21 from a burner of 1100° C. is applied directly by moving the burner, as shown in FIG. 4A.

FIG. 4B is showing a sectional view of FIG. 4A. The dummy glass rod 20A and dummy pipe 20B are welded on end side B in order to prevent Boron from passing from A end side to end side B. The thickness of dummy pipe 20B on the end side A is larger than that of the dummy pipe 20C so that the dummy glass rod 20A and the stress applying member 14 can be inserted into the through holes h1 and h2 from the end side A, but may not be passed through the through holes h1 and h2 from the end side B. At this time, a clearance C is left between the stress applying member 14 and an inner wall of the through hole h1, h2 so that a gas can be passed through it, as shown in FIG. 4B.

In this step, the inner wall of the through hole h1, h2 and the side circumferential face of the stress applying member 2 are cleaned excellently for purification. Thereafter, the interior of bore is replaced with helium gas without exposing the inner face of bore to atmosphere so that the interior of the bore is evacuated to seal.

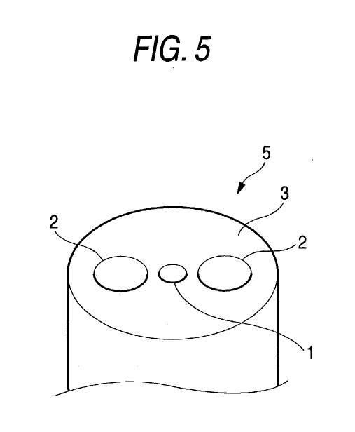

Then, the glass rod 15 is heated to about 2000° C. by employing a heating furnace. A drawing is performed to form the PMF 5, as shown in an enlarged view of FIG. 5.

That is, first of all, the glass rod 5 using optical fiber with the stress applying member 2 is heated to about 2000° C. in the heating furnace. Then, the glass rod is drawn at a linear velocity of 100 mm per minute to have an outer diameter of 125 μm while assembling the stress applying member.

The drawn optical fiber 5 with the stress applying member 2 is coated with UV resin twice. The outer diameter of coated optical fiber is about 250 μm.

In this manner, a PMF 5, which includes a core 1, a clad 3 and a stress applying member 2, is obtained. The PMF 5 has a length of 10 km. The PMF obtained in the above manner had a fluctuation of about 0.34 per 1km in an outer diameter so that a high yield is achieved.

The PMF was formed in the same manner, except that in the cleaning process, a temperature of the direct flame was changed to 700° C. and 1600° C.

The results are listed in a table 1 below.

TABLE 1

| | | Heating | | | |
|---|---|---|---|---|---|
| | Direct | in | Direct | Direct | |
| | flame | induction | flame | flame | No |
| | 1100° C. | furnace | 700° C. | 1600° C. | heating |
| Fluctuation | 0.34 | 0.46 | 2.28 | Cracking | More |
| in an outer | | | | at stress | than 10 |
| diameter | | | | applying | |
| | | | | member | |

Consequently, the glass rod with the stress applying member heated by direct flame at 700° C. has an increased fluctuation in outer diameter of 2.28 sites per km. This is because a dirt adhering on the inner face of bore cannot be fully removed and the fluctuation in outer diameter occurs frequently at the time of drawing.

The same experiment was conducted by further increasing the temperature to higher than 1600° C. As a result, the stress applying member of the glass rod was cracked so that the drawing was impossible.

Without heating, the fluctuation in outer diameter was more than 10 sites per kilometer

Also, the same experiment was conducted by heating the glass rod with the stress applying member to 1100° C. employing an induction furnace. As a result, the fluctuation in outer diameter was about 0.46 per kilometer.

In this manner, prior to fixing the stress applying member, the glass rod the glass rod with the stress applying member is heated in a chlorine atmosphere for better cleaning. It is possible to suppress the fluctuation in outer diameter at the time of wire drawing.

Also, the glass rod and the stress applying member are integrated at the step of drawing in order to avoid cracking of the glass rod at the time that crack is more likely to occur. It is possible to reduce the occurrence of crack.

Also, the dirt within the bore of the glass rod with the stress applying member can be removed by setting the heating temperature at 800 to 1500° C. It is considered that below 700° C. a cleaning reaction is not fully excited, and the contamination is not fully removed but remains within the bore.

Above 1500° C. the stress applying member may be cracked. If the stress applying member is cracked, the integration of the glass rod and the stress applying member is not sufficiently made at the time of drawing. As a result, the PMF cannot attain the predetermined conservation characteristic.

Moreover, the dirt within the bore of the glass rod with the stress applying member may be prevented excellently by heating in the chlorine atmosphere.

Herein, the furnace for cleaning is not limited to direct flame, but may be resistance heating, or an electric furnace or induction furnace.

A second embodiment of the invention will be described below.

In the first embodiment, the stress applying member is inserted into the through hole. Then the glass rod and the stress applying member are heated and cleaned.

However, in the second embodiment, prior to inserting the stress applying member, the glass rod with the stress applying member are heated in the chlorine gas atmosphere respectively. Then the stress applying member 14 is inserted into the through hole h1, h2, without exposure to the atmosphere. The glass rod with the stress applying member is drawn in the same manner as in the first embodiment.

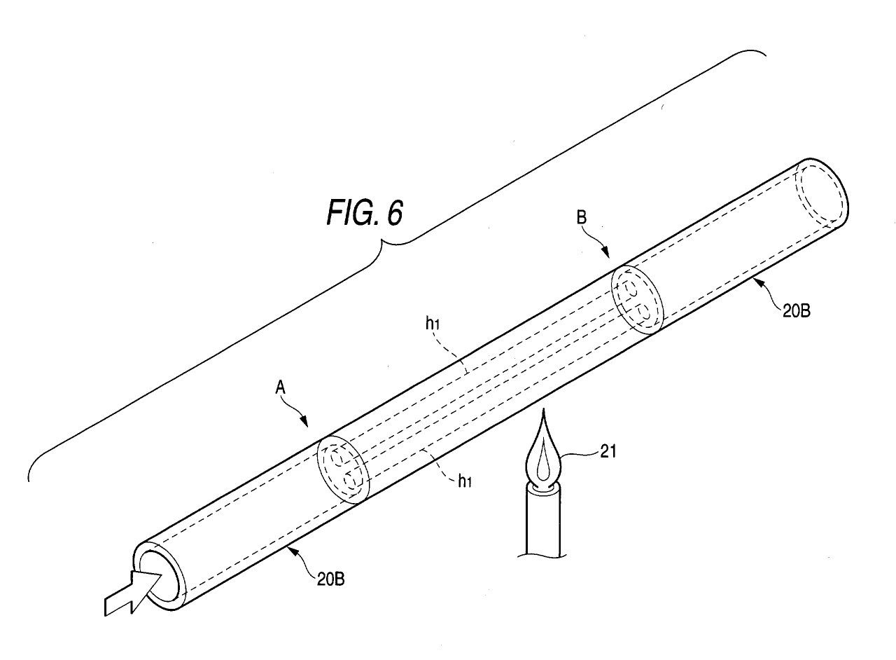

AS Shown in FIG. 6, the through holes h1 and h2 are formed, the glass rod using optical fiber is heated to 1100° C. by direct flame from the burner 21 in the chlorine atmosphere in the same manner as in the first embodiment so that the glass rod using optical fiber 15 with inner walls of the through holes h1 and h2 is cleaned.

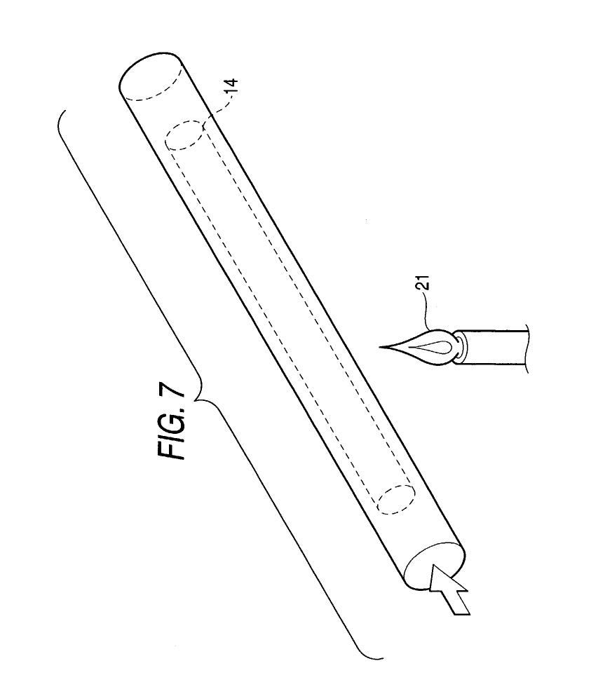

The stress applying member 14 is also heated to 1100° C. by direct flame from the burner 21 in the chlorine atmosphere, and cleaned, as shown in FIG. 7.

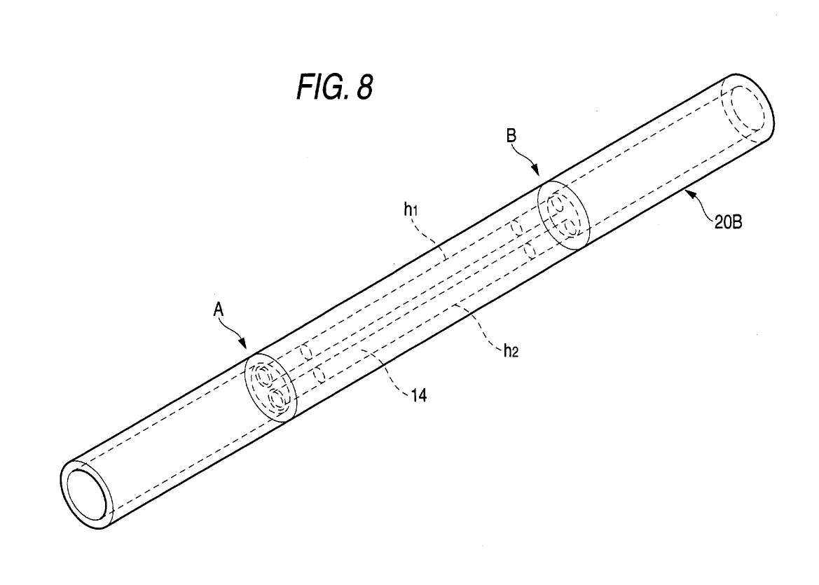

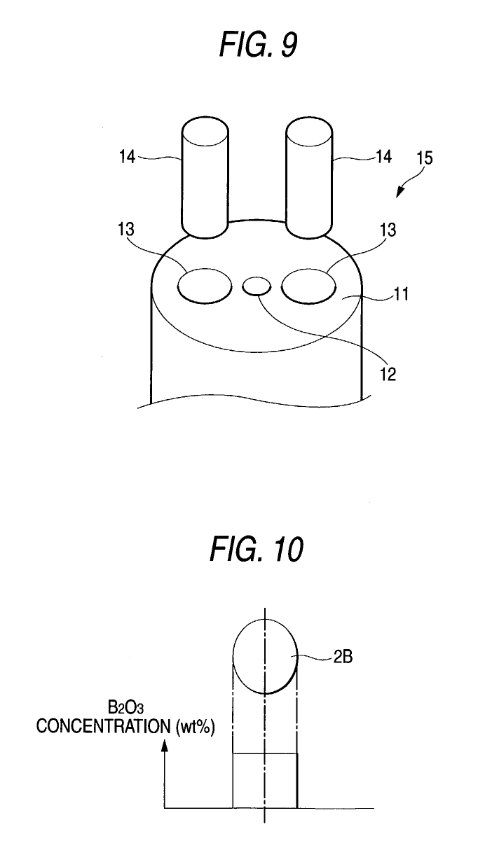

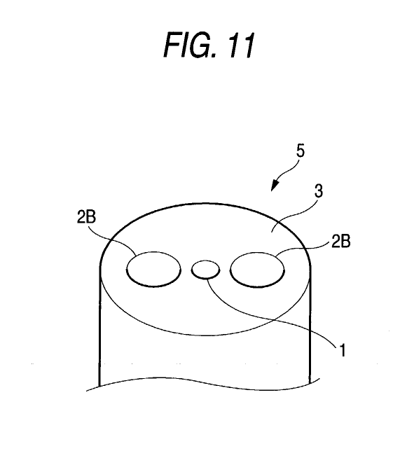

Then, the cleaned stress applying member 14 including a quartz rod with B₂O₃ added is inserted from a first end A of the cleaned through holes h1 and h2 to a second end B, without exposure to the atmosphere, as shown in FIG. 8. At this time, prior to inserting this stress applying member, a thicker dummy pipe 20B is welded on the B end side or ahead to prevent Boron passing from A end side to B end side.

Thereafter, the interior of bore was replaced with helium gas without exposing the inner face of bore to the atmosphere, evacuated and sealed.

In this state, the glass rod is placed vertically with the A end side down, heated to about 2000° C. and drawn by the ordinary method to form the PMF 5.

Firstly, the glass rod using optical fiber with the stress applying member is heated to about 2000° C. in the heating furnace in order to integrated to be drawn at a linear velocity of 100 mm per minute to have an outer diameter of 125 μm.

The drawn optical fiber 5 is coated with UV resin twice. The outer diameter of optical fiber after coating is about 250 μm.

In this manner, the PMF 5 comprising the core 1, the clad 3 and the stress applying member 2 and having a length of 10 km is obtained.

In the above embodiment, chlorine gas is employed. However, chlorine gases such as silicon tetrachloride and halogen containing gases including sulfur hexafluoride (SF₆) may be employed.

Also, inert gases such as argon and nitrogen may be employed.

Moreover, in the above embodiment, heating is made employing the burner by direct flame, but may be made by resistance furnace or induction furnace.

As described above in the invention, the cleaning is performed by heating with a clearance between the stress applying member and the through hole, prior to drawing, and heat-drawing is performed without exposure to the atmosphere, whereby the PMF can be produced at a high yield without causing any fluctuation in outer diameter or any crack.

What is claimed is:

1. A production method of a polarization maintaining fiber, the method comprising the steps of:
forming two or more bores at predetermined intervals in a glass rod including a core and a clad so that said two or more bores are located on a concentric circle around a center axis of said glass rod;
inserting a stress applying member into said bores;
heating said glass rod including the core and the clad and said stress applying member before or after inserting said stress applying member into the bore of the glass rod; and
drawing said glass rod with said stress applying member inserted in said bore without exposure to atmosphere after heating said glass rod with said stress applying member.

2. The production method according to claim 1, wherein said glass rod and said stress applying member are heated with a clearance between an outer side face of said stress applying member and an inner wall of said bore after inserting said stress applying member into said bores.

3. The production method according to claim 2, wherein said glass rod and said stress applying member are heated at temperature to keep the clearance in a condition that a gas flows through the clearance.

4. The production method according to claim 1, wherein said glass rod and said stress applying member are respectively heated before inserting said stress applying member into said bores.

5. The production method according to claim 1, wherein said glass rod and said stress applying member are heated at temperatures from 800 to 1500° C.

6. The production method according to claim 1, wherein said glass rod and said stress applying member are respectively heated in a halogen gas atmosphere.

7. The production method according to claim 6, wherein said glass rod and said stress applying member are heated in a chlorine gas atmosphere.

8. The production method according to claim 1, wherein said glass rod and said stress applying member are heated in an electric furnace.

9. The production method according to claim 1, wherein said glass rod and said stress applying member are heated directly by flame.
